(19) United States
(12) Patent Application Publication
(10) Pub. No.: US 2019/0127222 A1
(43) Pub. Date: May 2, 2019

(54) Boron Nitride Nanomaterial, and Preparation Method and Use Thereof

(71) Applicant: Suzhou Institute of Nano-Tech and Nano-Bionics (Sinano), Chinese Academy of Sciences, Suzhou (CN)

(72) Inventors: Yagang Yao, Suzhou (CN); Taotao Li, Suzhou (CN)

(21) Appl. No.: 16/306,758

(22) PCT Filed: Dec. 16, 2016
(86) PCT No.: PCT/CN2016/110420

§ 371 Date: Dec. 3, 2018

(30) Foreign Application Priority Data
Jul. 22, 2016 (CN) 201610583620.1
Jul. 22, 2016 (CN) 201610584210.9
Jul. 22, 2016 (CN) 201610584293.1

(51) Int. Cl. C01B 21/064; B01J 19/00

(52) U.S. Cl. CPC C01B 21/0641; B82Y 40/00; B01J 19/0013; C01B 21/0648

(57) ABSTRACT

The present disclosure discloses a boron nitride nanomaterial, and preparation method and use thereof. The preparation method comprises: heating a precursor in a nitrogen atmosphere to a high temperature, to prepare the boron nitride nanomaterial. The precursor comprises boron, and at least one metal element, and/or at least one non-metallic element rather than boron, the metal element is at least one selected from the group consisting of lithium, beryllium, magnesium, calcium, strontium, barium, aluminum, gallium, indium, zinc, and titanium, and the non-metallic element comprises silicon. The preparation method of the boron nitride nanomaterial provided by the disclosure is simple, controllable, and economical with readily available and inexpensive starting materials, and high conversion rates of the starting materials, and facilitates mass production. Furthermore, the obtained boron nitride nanomaterials further have advantages, such as excellent quality, and controllable appearance, and have very good application prospects in many fields, such as electronic devices, deep ultraviolet light emitting, composite materials, heat dissipating materials, friction materials, drug loading, and catalyst loading.

### TECHNICAL FIELD

The disclosure relates to a preparation method of a boron nitride material, specifically relates to a boron nitride nanomaterial, preparation method and use thereof, and belongs to the technical field of an inorganic nanomaterial.

### BACKGROUND

The boron nitride nanomaterial has many excellent physical and chemical properties, including excellent mechanical strength, high thermal conductivity, wide direct band gap, good chemical inertness (corrosion resistance, resistance to high temperature oxidation), large specific surface area, and the like, and has wide application prospects in many fields, such as electronic devices, deep ultraviolet light emitting, composite materials, heat dissipating materials, friction materials, drug loading, and catalyst loading.

For example, the boron nitride nanosheet (BNNS) has a planar six-membered ring structure similar to graphene, has a lattice constant best matching graphene, is known as the “white graphene”, and has excellent electrical insulating property, high thermal conductivity coefficient, wide direct band gap, and good chemical inertness (corrosion resistance, resistance to high temperature oxidation), good biocompatibility, large specific surface area, and the like. At present, the synthetic methods of the BNNS include “top-down approach”, “bottom-up approach”, and the like. The “top-down approach” means to obtain the BN nanosheet by stripping micron-sized BN particles layer by layer. The “top-down approach” includes the liquid phase stripping method, mechanical stripping method, liquid phase-mechanical stripping, molten alkali stripping, molten salt stripping, etc. These methods are economical, but suffer from long production cycle, complex processes, low efficiency, and low yields, and fail to meet the industrial requirements. Most of other approaches, such as “chemical bubbling”, and substitution approach, also have the disadvantages, such as high costs, failure to facilitate mass production, low yields, and poor product quality. The “bottom-up approach” includes chemical vapor deposition (CVD), and the like. The CVD enables a boron-containing gas to react with a nitrogen-containing gas (such as BF₃ and NH₃) at a high temperature, or a gas molecule containing both boron and nitrogen (such as B₃N₃H₆) to be decomposed at a high temperature, and deposited on the surface of a substrate having a catalytic activity (metallic substrate, such as copper, nickel, or ruthenium), to obtain the boron nitride nanosheet (or continuous film). The boron nitride nanosheet synthesized by the method has good crystal quality and large sheet size, has an atomic level flat surface, is a desired substrate material of the materials, such as high-quality graphene, and a transition metal disulfide, and has wide application prospects in respect of the electronic device. However, the BNNS prepared by the existing CVD must be transferred onto the silicon substrate to make into a device, suffers from low yield, and complex synthetic process, and is less competitive in use in the fields, such as composite materials, heat dissipating materials, friction materials, drug loading, and catalyst loading. Furthermore, some researchers have synthesized the boron nitride nanosheet on a silicon substrate, but the method still requires depositing a layer of metal on the silicon substrate as a catalyst. There is a metal between the silicon substrate and the boron nitride nanosheet after completing growth, thereby failing to be directly used with silicon wafers in the device.

As another example, due to its special tubular structure, large length to diameter ratio, piezoelectric effect, and the like, the boron nitride nanotube (BNNT) can be used as composite material reinforcement, catalyst carriers, and novel pressure sensors, and can also be used as the transport channel of small molecules to study the transport mechanism thereof. At present, the reported synthetic method of the boron nitride nanotubes includes arc discharge, laser ablation, ball milling and annealing, chemical vapor deposition, template method, and the like. However, it is still a difficult problem to control the wall diameter and the number of walls of the BNNT in the above methods, and what is most important is that it is difficult to achieve mass preparation of the BNNT.

As still another example, the boron nitride nanoribbon (BNNR) can be regarded as a ribbon-shaped boron nitride nanosheet, and its width is between nanosizes. Due to its special sideband structure, including abundant unsaturated bonds and modificability, it further shows specific physical properties, such as width-controlled narrow band, and special magnetic properties, and has attractive application prospects in respect of nano-electronic devices, spin electronic devices, optoelectronic devices, sensors, composites, and the like. Moreover, in respect of the use in composite materials, its special edge structure also enables the BNNR to have better interfacial bonding to the substrate, and shows more remarkable enhancement effect than the BNNT and BNNS. At present, the preparation method of the boron nitride nanoribbon is to axially cut the boron nitride nanotubes mainly using plasma, or an alkali metal vapor to obtain the nanoribbon. However, these methods have high requirements for the device, or require harsh conditions, and have certain risks, and result in very low yields. Some other methods, such as generating the BNNR by an in-situ reaction, have the disadvantages, such as low yields.

Throughout the current production technology of the boron nitride nanomaterial, the high costs and low efficiency seriously restrict further scientific research and practical application. It is of very significant practical significance to develop a low-cost and efficient preparation technology of a novel boron nitride material.

### SUMMARY

A main object of the disclosure is to provide a boron nitride nanomaterial, and preparation method and use thereof, to overcome the disadvantages of the existing technologies.

In order to achieve the foregoing object of the disclosure, the technical solution adopted in the disclosure includes:

An embodiment of the disclosure provides a preparation method of a boron nitride nanomaterial, including: heating a precursor in a nitrogen atmosphere to 1000-1500° C., and thermostatically controlling the precursor to prepare the boron nitride nanomaterial. The precursor includes boron, and at least one metal element, and/or at least one non-metallic element rather than boron. The metal element is at least one selected from the group consisting of lithium, beryllium, magnesium, calcium, strontium, barium, aluminum, gallium, indium, zinc, and titanium. The non-metallic element includes silicon.

In some embodiments, the preparation method includes: using a solid boron source as the precursor, heating the solid boron source in the nitrogen atmosphere to 1000-1500° C., thermostatically controlling the solid boron source, then cooling to room temperature in a protective atmosphere to obtain a crude product, and then post-processing the crude product to obtain a boron nitride nanosheet powder. The solid boron source is selected from borates, and the boron source is selected from borates containing at least one element of lithium, beryllium, magnesium, calcium, strontium, barium, aluminum, gallium, indium, zinc, or titanium.

In some embodiments, the preparation method includes: using a precursor film coated on a substrate as the precursor, heating the precursor film in a nitrogen atmosphere to 1000-1400° C., and thermostatically controlling the precursor film, to prepare a continuous boron nitride nanosheet film. The precursor film includes at least three elements, where two elements thereof are boron, and oxygen respectively, while the other element is any one selected from the group consisting of lithium, beryllium, magnesium, calcium, strontium, barium, aluminum, gallium, indium, zinc, titanium, and silicon, and a combination of two or more thereof.

In some embodiments, the preparation method includes: using a one-dimensional borate precursor as the precursor, heating the one-dimensional borate precursor in the nitrogen atmosphere to 1000-1500° C., thermostatically controlling the one-dimensional borate precursor, then cooling to room temperature in a protective atmosphere to obtain a crude product, and then post-processing the crude product to obtain a one-dimensional boron nitride nanomaterial. The one-dimensional borate precursor is selected from one-dimensional borate materials containing at least one element of lithium, beryllium, magnesium, calcium, strontium, barium, aluminum, gallium, indium, zinc, or titanium.

An embodiment of the disclosure further provides a plurality of boron nitride nanomaterials prepared by the foregoing method, including the boron nitride nanosheet powder, the continuous boron nitride nanosheet film, the one-dimensional boron nitride nanomaterial, and the like.

An embodiment of the disclosure further provides use of the plurality of boron nitride nanomaterials prepared by the foregoing method.

Compared with the existing technologies, the preparation method of the boron nitride nanomaterial provided by the disclosure is simple, controllable, and economical with readily available and inexpensive starting materials, and high conversion rates of the starting materials, and facilitates mass production. Furthermore, the obtained boron nitride nanomaterials further have advantages, such as excellent quality, and controllable appearance, and have very good application prospects in many fields, such as electronic devices, deep ultraviolet light emitting, composite materials, heat dissipating materials, friction materials, drug loading, and catalyst loading.

### BRIEF DESCRIPTION OF THE DRAWINGS

FIG. 1 is an image of a BN nanosheet powder entity obtained in the embodiment 1.

FIG. 2 is a TEM appearance image of a BNNS powder obtained in the embodiment 1.

FIG. 3 is a SEM image of a BN nanosheet obtained in the embodiment 2.

FIG. 4 is an XRD pattern of a BNNS obtained in the embodiment 2.

FIG. 5 is a TEM image of a product obtained in the embodiment 2.

FIG. 6 is a Raman spectrum of a BNNS obtained in the embodiment 3.

FIG. 7 is a TEM image of a BNNS obtained in the embodiment 4.

FIG. 8 is a SEM image of a BNNT obtained in the embodiment 20.

FIG. 9 is a TEM image of the BNNT obtained in the embodiment 20.

FIG. 10 is an XRD pattern of the BNNT obtained in the embodiment 20.

FIG. 11 is a Raman spectrum of the BNNT obtained in the embodiment 20.

FIG. 12 is a SEM image of a BNNT obtained in the embodiment 21.

FIG. 13 is a Raman spectrum of the BNNT obtained in the embodiment 21.

### DETAILED DESCRIPTION OF EMBODIMENTS

To make the object, technical solution, and advantages of the disclosure to become more apparent, specific embodiments of the disclosure are illustrated in detail hereinafter. The embodiments of the disclosure are only exemplary, and are not intended to limit the disclosure.

A preparation method of a boron nitride nanomaterial provided by an embodiment of the disclosure may include: heating a precursor in a nitrogen atmosphere to 1000-1500° C., and thermostatically controlling the precursor to prepare the boron nitride nanomaterial. The precursor includes boron, and at least one metal element, and/or at least one non-metallic element rather than boron. The metal element is at least one selected from the group consisting of lithium, beryllium, magnesium, calcium, strontium, barium, aluminum, gallium, indium, zinc, and titanium. The non-metallic element includes silicon.

Furthermore, the inventor of the disclosure has found through prolonged researches and a considerable amount of practice that when a borate containing at least one element of lithium, beryllium, magnesium, calcium, strontium, barium, aluminum, gallium, indium, zinc, or titanium is used to react with a nitrogen source, such as ammonia, or nitrogen, at a high temperature, a high-quality two-dimensional boron nitride nanosheet with high yield can be obtained.

Accordingly, in some embodiments of the disclosure, the preparation method may include: using a solid boron source as the precursor, heating the solid boron source in the nitrogen atmosphere to 1000-1500° C., thermostatically controlling the solid boron source, then cooling to room temperature in a protective atmosphere to obtain a crude product, and then post-processing the crude product to obtain a boron nitride nanosheet powder. The solid boron source is selected from borates, and the boron source is selected from borates containing at least one element of lithium, beryllium, magnesium, calcium, strontium, barium, aluminum, gallium, indium, zinc, or titanium.

The solid boron source in the foregoing embodiments may be preferably selected from the group consisting of calcium borate (CaB₄O₇, Ca₂B₂O₅, Ca₃B₂O₆), magnesium borate (MgB₄O₇, MgB₂O₅, Mg₃B₂O₆), lithium borate (Li₂B₄O₇), and borates of a metal, such as aluminum, or zinc, and a mixture thereof. Moreover, almost all crystal forms of these borates are applicable for the foregoing embodiments of the disclosure.

Preferably, the preparation method may further include: heating the boron source in a reactive atmosphere to a temperature of higher than 1250° C., and lower than or equal to 1500° C., and thermostatically controlling the boron source.

Further preferably, the preparation method may further include: heating the boron source in a reactive atmosphere to a temperature of higher than 1250° C., and lower than or equal to 1500° C. for more than 0.5 hour, e.g., 0.5-5 hours.

The nitrogen atmosphere in the foregoing embodiments may be preferably selected from, but is not limited to, the group consisting of an ammonia atmosphere, a nitrogen atmosphere, and a mixed atmosphere formed by at least one of ammonia or nitrogen, and argon.

The protective atmosphere in the foregoing embodiments may be preferably selected from, but is not limited to, the group consisting of a nitrogen atmosphere, an argon atmosphere, and a mixed atmosphere of nitrogen and argon.

In the foregoing embodiments, the post-processing may include: washing the crude product with an acid solution, filtering, and then drying the crude product at 60-80° C. for 1-12 hours, to obtain the boron nitride nanosheet.

The crude product in the foregoing embodiment is a composite or a mixture of the boron nitride nanosheet and a corresponding metal oxide. The oxide is a by-product, and can be washed with an acid solution.

For example, the concentration of the acid solution may be any appropriate concentration, for example, preferably greater than 0.1 mol/L. The acid contained therein can react with a byproduct in the crude product to form a soluble substance.

In the foregoing embodiments, the post-processing may further specifically include: fully washing the crude product with the acid solution in combination with a mechanical method; and the mechanical method includes stirring or ball milling. The washing process is combined with the mechanical method to achieve thorough washing.

In the foregoing embodiments, the preparation method may further specifically include: collecting a soluble byproduct formed by a reaction between the byproduct in the crude product and the acid solution for washing in the post-processing, and using the soluble byproduct for synthesizing the boron source. For example, a byproduct MgO is washed with an acid solution to form a corresponding salt solution (MgCl₂, Mg(NO₃)₂, MgSO₄, or other solution), can be used as a starting material for synthesizing magnesium borate after extracting crystal, and is an environment friendly synthetic method.

A boron nitride nanosheet powder prepared by the foregoing embodiments is a hexagonal boron nitride nanosheet having a purity of higher than 99%. The hexagonal boron nitride nanosheet has a thickness of 1-20 atomic layers, and a radial dimension of 1-20 μm.

In a typical embodiment of the disclosure, a preparation method of a boron nitride nanomaterial is a low-cost mass preparation method of the boron nitride nanosheet powder, which may include following steps:

(1) Heating a boron source in an ammonia atmosphere to a temperature of 1000-1500° C. (preferably higher than 1250° C., and lower than or equal to 1500° C.), thermostatically controlling the boron source for 0.5-5 hours, and cooling to room temperature under the protection of nitrogen or argon, to obtain a white crude product.
(2) Purifying, filtering, and drying the crude product obtained from the step (1), to obtain the boron nitride nanosheet powder having a purity of higher than 99%. By the foregoing method, according to the amount of the precursor and the volume of the device, the yield of a single batch can reach more than a gram level. The net yield (by boron equivalent) is up to 85% under a preferable synthesis condition.

More specifically, the foregoing embodiments relate to following chemical reactions (taking a reaction of tricomponent magnesium borate in ammonia as an example):

MgB₄O₇+4NH₃→4BN+MgO+6H₂O

Mg₂B₂O₅+2NH₃→2BN+2MgO+3H₂O.

Mg₃B₂O₆+2NH₂→2BN+3MgO+3H₂O

Preferably, the step (1) may include: heating the boron source in an ammonia atmosphere to a temperature of 1000-1500° C., thermostatically controlling the boron source for 0.5-4 hours, and cooling to room temperature under the protection of nitrogen or argon, to obtain a white crude product. For example, one reaction equation thereof is: Li₂B₄O₇+4NH₃→4BN+Li₂O+6H₂O.

Preferably, the purifying in the step (2) may include: washing with water 3-5 times. After washing, filtering, and other operations, the reaction byproducts can be effectively removed, to obtain a high-purity BN nanosheet.

Preferably, the drying in the step (2) may include: drying at 60-80° C. for 6-12 hours.

Through the foregoing embodiments, in particular, the hexagonal boron nitride two-dimensional ultrathin nanosheet (hexagonal boron nitride nanosheet) prepared in the foregoing typical embodiments has a thickness of 1-20 atomic layers, a size of 1-20 μm, and macroscopically presents a powder form.

The hexagonal boron nitride two-dimensional ultrathin nanosheet prepared in the foregoing embodiments can be used in many fields, such as deep ultraviolet light emitting, composite materials, heat dissipating materials, friction materials, drug loading, and catalyst carriers.

In some other embodiments of the disclosure, the preparation method may include: using a precursor film coated on a substrate as the precursor, heating the precursor film in a nitrogen atmosphere to 1000-1400° C., and thermostatically controlling the precursor film, to prepare a continuous boron nitride nanosheet film. The precursor film includes at least three elements, where two elements thereof are boron, and oxygen respectively, while the other element is any one selected from the group consisting of lithium, beryllium, magnesium, calcium, strontium, barium, aluminum, gallium, indium, zinc, titanium, and silicon, and a combination of two or more thereof.

Furthermore, a component of the precursor film can be expressed as (MₓO_{y})ₘ.(B₂O₃)ₙ, where m/n=1:10-1000:1, if M is a monovalent metal ion (e.g., lithium), then x=2y, if M is a divalent metal ion (e.g., beryllium, magnesium, calcium, strontium, barium, or zinc), then x=y, if M is a trivalent metal ion (aluminum, gallium, indium, or titanium), then 2y=3x, and if M is a tetravalent Si ion, then y=2x.

Preferably, the precursor film in the foregoing embodiments can be directly formed on the substrate surface.

Preferably, the precursor contained in the precursor film in the foregoing embodiments is (Al₂O₃)ₘ.(B₂O₃)ₙ, where m/n is 1:1-1000:1.

Preferably, the precursor contained in the precursor film in the foregoing embodiments is (SiO2₃)ₘ.(B₂O₃)ₙ, where m/n is 1:1-1000:1.

In the foregoing embodiments, the preparation method specifically may include:

(1) depositing a layer of precursor film on the substrate; and
(2) obtaining the continuous boron nitride nanosheet film through a reaction in an atmosphere containing ammonia and\or nitrogen at a high temperature.

As one of the preferred embodiments, the preparation method may include: depositing a layer of BₓSi₁₋ₓO precursor film having a thickness of 1-500 nm on a substrate using a magnetron sputtering approach; and then obtaining the continuous boron nitride nanosheet film through a reaction in an ammonia atmosphere at a high temperature.

As one of the preferred embodiments, the preparation method may further include: coating the precursor film on the substrate, then heating the precursor film in a nitrogen atmosphere to 1000-1400° C., and thermostatically controlling the precursor film for more than 10 minutes, e.g., 10-300 minutes, thereby forming the continuous boron nitride nanosheet film on the surface of the substrate.

As one of the preferred embodiments, the preparation method may further include: coating the precursor film on the substrate (e.g., a silicon substrate), then heating the precursor film in the nitrogen atmosphere to 1000-1400° C., and thermostatically controlling the precursor film, thereby forming the continuous boron nitride nanosheet film on the surface of the substrate, and forming an insulating medium layer, such as a metal oxide layer, or a silicon oxide layer, on the substrate and the continuous boron nitride nanosheet film, so as not to hinder, or even contribute to subsequent device design and manufacture.

In the foregoing embodiments, representative reaction equations are as follows:

(Al₂O₃)ₘ.(B₂O₃)ₙ+2nNH₃—mAl₂O₃+2nBN+3nH₂O

(SiO₂)ₘ.(B₂O₃)ₙ+2nNH₃—mSiO₂+2nBN+3nH₂O

In the foregoing embodiments, the preparation method may further include: forming the precursor film by depositing on the surface of the substrate using at least one approach of magnetron sputtering, electron beam evaporation, thermal evaporation, pulsed laser deposition, molecular beam epitaxy, or atomic layer deposition.

Preferably, a thickness of the precursor film in the foregoing embodiments is 1-500 nm.

Preferably, the nitrogen atmosphere in the foregoing embodiments is selected from ammonia, and/or nitrogen, and/or a mixed atmosphere formed by ammonia, and/or nitrogen, and a diluent gas, and the diluent gas includes, but is not limited to, an inert gas (e.g., argon).

Preferably, the substrate in the foregoing embodiments includes, but is not limited to, a silicon (Si) substrate, or a silicon oxide (Si/SiO₂) substrate.

Preferably, there is no metal catalyst layer between the continuous boron nitride nanosheet film and the substrate in the foregoing embodiments.

Further preferably, the continuous boron nitride nanosheet film directly grows on the surface of the substrate in the foregoing embodiments.

A continuous boron nitride nanosheet film prepared by the foregoing embodiments is formed by aggregation of hexagonal boron nitride nanosheet monocrystals having a size of 1-50 μm (similar to a polycrystal splicing form, having a crystal boundary). A thickness of the continuous boron nitride nanosheet film is between 1 and 100 atomic layers.

Embodiments of the disclosure further provide use of a continuous boron nitride nanosheet film prepared by the foregoing embodiments, e.g., use in the preparation of a two-dimensional nanomaterial or a device including the two-dimensional nanomaterial.

The two-dimensional nanomaterial includes, but is not limited to, graphene.

In some typical embodiments, the continuous boron nitride nanosheet film can be directly synthesized on the silicon substrate without any transfer process. Furthermore, the continuous boron nitride nanosheet film can be directly used as a growth substrate for graphene to form a substrate and/or grid electrode of a graphene device. The process is simple and controllable, has wide application prospects in respect of the graphene device, and can achieve mass production.

Furthermore, the inventor of the disclosure has further found through prolonged researches and a considerable amount of practice that when a one-dimensional borate containing at least one element of lithium, beryllium, magnesium, calcium, strontium, barium, aluminum, gallium, indium, zinc, or titanium is used to react with a nitrogen source, such as ammonia, or nitrogen, at a high temperature, a high-quality one-dimensional boron nitride nanomaterial with high yield can be obtained.

Accordingly, in some other embodiments of the disclosure, the preparation method may include: using a one-dimensional borate precursor as the precursor, heating the one-dimensional borate precursor in the nitrogen atmosphere to 1000-1500° C., thermostatically controlling the one-dimensional borate precursor, then cooling to room temperature in a protective atmosphere to obtain a crude product, and then post-processing the crude product to obtain a one-dimensional boron nitride nanomaterial. The one-dimensional borate precursor is selected from one-dimensional borate materials containing at least one element of lithium, beryllium, magnesium, calcium, strontium, barium, aluminum, gallium, indium, zinc, or titanium.

The one-dimensional borate material in the foregoing embodiments may be selected from, but is not limited to, the group consisting of a borate whisker, a borate nanorod, a borate nanowire, a borate nanoribbon, and the like.

Preferably, the preparation method includes: heating the one-dimensional borate precursor in a nitrogen atmosphere to a temperature of higher than 1200° C., and lower than or equal to 1500° C., and thermostatically controlling the one-dimensional borate precursor.

Further preferably, the preparation method includes: heating the one-dimensional borate precursor in a nitrogen atmosphere to a temperature of higher than 1200° C., and lower than or equal to 1300° C., and thermostatically controlling the one-dimensional borate precursor for a certain duration, e.g., more than 0.5 hour, preferably, e.g., 0.5-5 hours.

The nitrogen atmosphere in the foregoing embodiments may include, but is not limited to, an ammonia atmosphere, a nitrogen atmosphere, or a mixed atmosphere formed by at least one of ammonia or nitrogen, and argon.

The protective atmosphere in the foregoing embodiments includes, but is not limited to, a nitrogen atmosphere, an argon atmosphere, or a mixed atmosphere of nitrogen and argon.

In some embodiments, the post-processing includes: washing the crude product with an acid solution, filtering, and then drying the crude product, to obtain the one-dimensional boron nitride nanomaterial.

In some specific embodiments, the post-processing includes: washing the crude product with an acid solution, filtering, and then drying the crude product at 60-80° C. for 1-12 hours, to obtain the one-dimensional boron nitride nanomaterial.

Furthermore, the concentration of the acid solution is preferably 0.1-6 mol/L. The acid contained therein can react with a byproduct in the crude product to form a soluble substance.

Preferably, the preparation method may further include: collecting a soluble byproduct formed by a reaction between the byproduct in the crude product and the acid solution for washing in the post-processing, and using the soluble byproduct for synthesizing the one-dimensional borate precursor.

In a typical embodiment of the disclosure, the preparation method may further include following steps:

(1) Heating a boron source in an ammonia atmosphere to a temperature of 1000-1500° C. (preferably higher than 1200° C., and lower than or equal to 1300° C.), thermostatically controlling the boron source for 0.5-5 hours, and cooling to room temperature under the protection of nitrogen or argon, to obtain a white crude product; and
(2) Purifying, filtering, and drying the crude product obtained from the step (1), to obtain the one-dimensional boron nitride nanomaterial having a purity of higher than 99%.

By the foregoing method, according to the amount of the precursor and the volume of the device, the yield of a single batch can reach more than a gram level. The yield (by boron equivalent) is up to 85% under a preferable synthesis condition.

A one-dimensional boron nitride nanomaterial prepared by the method in the foregoing embodiments includes a boron nitride nanotube, a boron nitride nanoribbon, or the like. Structure, appearance, and the like of the one-dimensional boron nitride nanomaterial depend on appearance and structure of the precursor.

Furthermore, a wall thickness of the boron nitride nanotube is between monoatomic layer and polyatomic layers, and its length and diameter depend on a length and a diameter of the employed precursor whisker or nanowire.

Furthermore, a thickness of the boron nitride nanoribbon is between monoatomic layer and polyatomic layers, and its width and length depend on a width and a length of the employed borate nanoribbon.

The one-dimensional boron nitride nanomaterial prepared by the method in the foregoing embodiments can be used in many fields, such as deep ultraviolet light emitting, composite materials, heat dissipating materials, friction materials, drug loading, and catalyst carriers.

The technical solution of the disclosure is illustrated in detail hereinafter in conjunction with the accompanying drawings and some embodiments.

### Embodiment 1

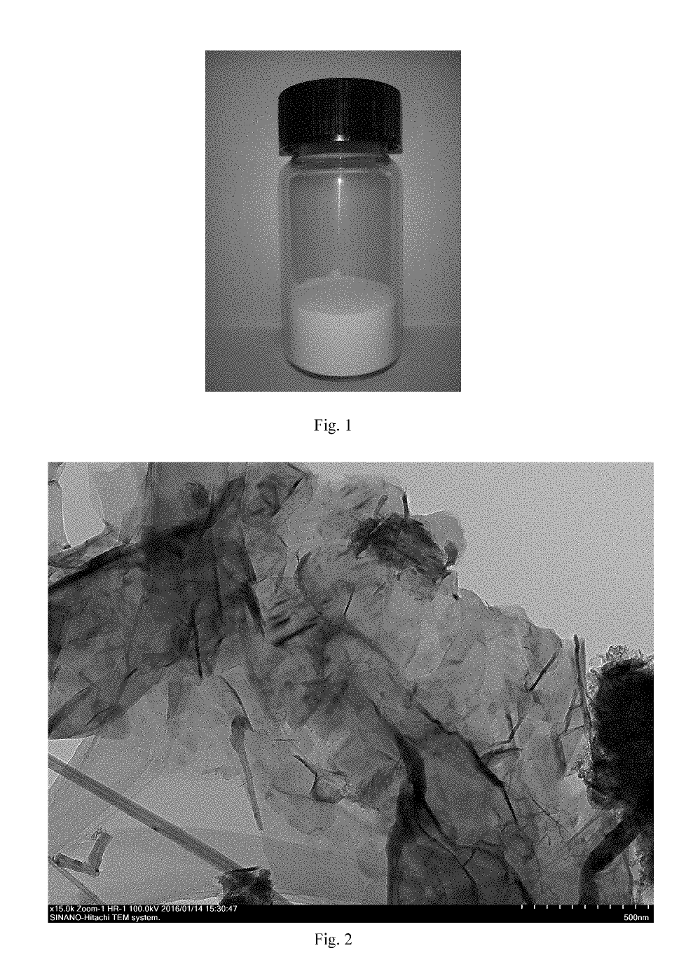

2 g of CaB₄O₇ was placed in an open alumina crucible, placed in a tube furnace, vacuumized to 10⁻³ Pa, and then heated to 1250° C. after introducing NH₃ at 200 standard cc/min (sccm). After thermostatically controlling the crucible at 1250° C. for 180 min, NH₃ supply was switched off to introduce N₂ at 200 sccm. The crucible was cooled to room temperature in an atmosphere of N₂, and taken out to obtain a crude product. Then the obtained product was ultrasonically washed with water for 5 hours, filtered, and dried, to obtain a boron nitride nanosheet powder having a purity of higher than 99%. The target product can be obtained with 95% yield in the embodiment. FIG. 1 is an image of a crude BN nanosheet product entity obtained in the embodiment. FIG. 2 is a TEM appearance image of a BNNS powder obtained in the embodiment, from which its micron size can be seen.

### Embodiment 2

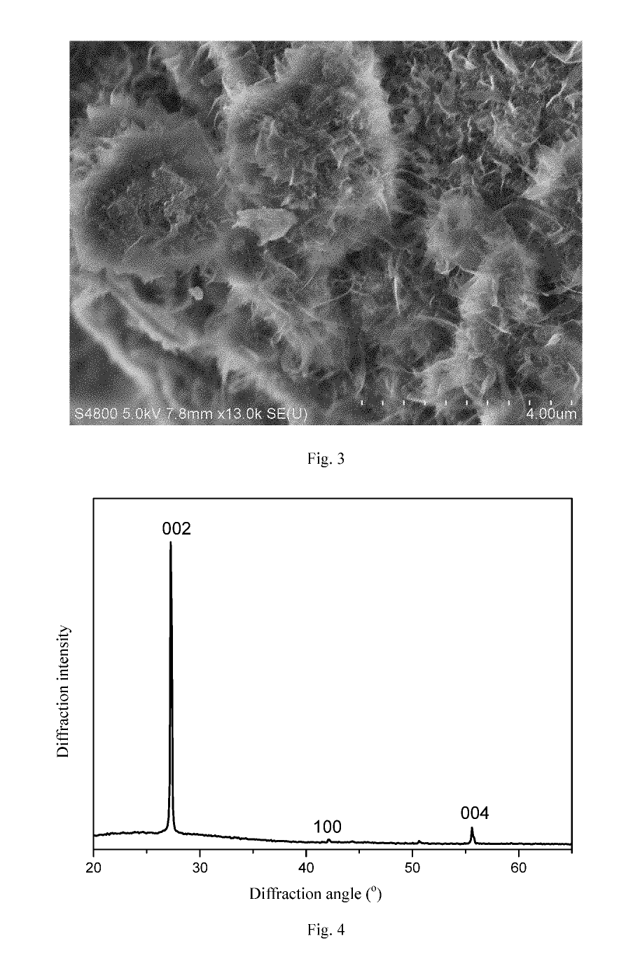

2 g of Mg₂B₂O₅ was placed in an open alumina crucible, and then placed in a tube furnace. Ar was introduced at 1000 standard cc/min (sccm) to eliminate air in a furnace tube. Then the crucible was heated to 1300° C. in an atmosphere of Ar at 200 sccm and NH₃ at 200 sccm. After thermostatically controlling the crucible at 1300° C. for 4 hours, NH₃ supply was switched off, and Ar was introduced at 500 sccm. The crucible was cooled to room temperature, and taken out to obtain a crude product. Then the obtained product was ultrasonically washed with 3 mol/L nitric acid for 1 hour, filtered, and dried, to obtain a boron nitride nanosheet powder having a purity of higher than 99%. The target product can be obtained with 85% yield in the embodiment. FIG. 3 is a SEM image of a BN nanosheet obtained in the embodiment, from which a flaky BN nanosheet can be observed. FIG. 4 is an XRD pattern of a BNNS obtained in the embodiment, which validates that the resulting product is a monophase hexagonal BN. FIG. 5 is a TEM image of a product obtained in the embodiment, which validates that the product is a micron-sized nanosheet.

### Embodiment 3

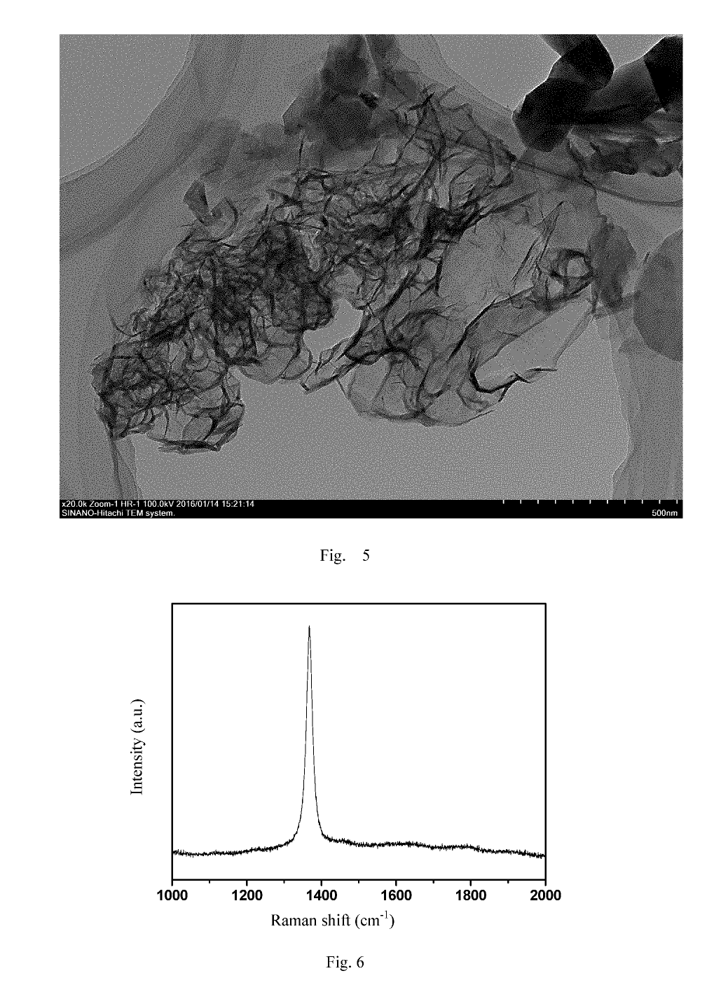

Al₄B₂O₉ was placed in an open alumina crucible, placed in a tube furnace, and vacuumized to 10⁻³ Pa. Then the crucible was heated to 1500° C. in an atmosphere of NH₃ at 300 sccm. After thermostatically controlling the crucible at 1500° C. for 120 minutes, NH₃ supply was switched off, and Ar was introduced at 200 sccm. The crucible was cooled to room temperature, and taken out to obtain a crude product. Then the obtained product was ultrasonically washed with 3 mol/L nitric acid for 5 hours, filtered, and dried, to obtain a boron nitride nanosheet powder having a purity of higher than 99%. The target product can be obtained with 95% yield in the embodiment. FIG. 6 is a Raman spectrum of a BNNS obtained in the embodiment. As can be concluded from a peak at 1367.9 cm⁻¹, the BNNS is a hexagonal BN.

### Embodiment 4

ZnB₄O₇ was placed in an open boron nitride crucible, placed in a tube furnace, and vacuumized to 10⁻³ Pa. Then the crucible was heated to 1300° C. in an atmosphere of NH₃ at 300 sccm. After thermostatically controlling the crucible at 1300° C. for 2 hours, NH₃ supply was switched off, and Ar was introduced at 200 sccm. The crucible was cooled to room temperature, and taken out to obtain a crude product. Then the obtained product was ultrasonically washed with water for 2 hours, filtered, and dried, to obtain a boron nitride nanosheet powder having a purity of higher than 99%. The target product can be obtained with 80% yield in the embodiment. FIG. 7 is a TEM image of a BNNS obtained in the embodiment. As can be seen from the figure, a thickness of its nanosheet is about 15 atomic layers.

### Embodiment 5

appropriate amounts of LiOH and B₂O₃ were mixed at a ratio of 1:1, placed in an open boron nitride crucible, placed in a tube furnace, and vacuumized to 10⁻³ Pa. Then the crucible was heated to 800° C. in an atmosphere of Ar at 300 sccm, and thermostatically controlled for 1 hour, to generate lithium borate Li₂B₄O₇ through a reaction. Then the crucible was heated to 1300° C., and Ar supply was switched off to introduce NH₃. After thermostatically controlling the crucible at 1300° C. for 3 hours, NH₃ supply was switched off to introduce Ar at 200 sccm. The crucible was cooled to room temperature, and taken out to obtain a crude product. Then the obtained product was washed with water for 5 hours by mechanical stirring, filtered, and dried, to obtain a boron nitride nanosheet powder having a purity of higher than 99%. The target product can be obtained with 80% yield in the embodiment.

### Embodiment 6

appropriate amounts of MgO and B₂O₃ were mixed at a ratio of 2:1, placed in an open boron nitride crucible, placed in a tube furnace, and vacuumized to 10⁻³ Pa. Then the crucible was heated to 1000° C. in an atmosphere of Ar at 300 sccm, and thermostatically controlled for 3 hours, to generate magnesium borate through a reaction. Then the crucible was heated to 1400° C., and Ar supply was switched off to introduce NH₃. After thermostatically controlling the crucible at 1400° C. for 3 hours, NH₃ supply was switched off to introduce Ar at 200 sccm. The crucible was cooled to room temperature, and taken out to obtain a crude product. Then the obtained product was washed with water for 5 hours by mechanical stirring, filtered, and dried, to obtain a boron nitride nanosheet powder having a purity of higher than 99%. The target product can be obtained with 85% yield in the embodiment.

### Embodiment 7

appropriate amounts of Al(OH)₃ and H₃BO₃ were mixed at a ratio of 9:2, placed in an open boron nitride crucible, placed in a tube furnace, and vacuumized to 10⁻³ Pa. Then the crucible was heated to 1000° C. in an atmosphere of Ar at 300 sccm, and thermostatically controlled for 3 hours, to generate aluminium borate through a reaction. Then the crucible was heated to 1500° C., and Ar supply was switched off to introduce NH₃. After thermostatically controlling the crucible at 1500° C. for 3 hours, NH₃ supply was switched off to introduce Ar at 200 sccm. The crucible was cooled to room temperature, and taken out to obtain a crude product. Then the obtained product was washed with water for 5 hours by mechanical stirring, filtered, and dried, to obtain a boron nitride nanosheet powder having a purity of higher than 99%. The target product can be obtained with 90% yield in the embodiment.

It should be noted that the foregoing embodiments 1-7 only illustrate the core contents of some embodiments in the disclosure by way of examples. The core of these embodiments is using a borate as a precursor. However, in practical production, the essence of the borate as a reactant may be hidden in some reaction processes, and is not easily recognized. For example, in embodiment 5, taking the preparation of boron nitride with B₂O₃ and LiOH as precursors as an example, two chemical reactions actually occur in the heating process: one is that lithium borate (Li₂B₄O₇, Li₃BO₃, LiBO₂, or the like) is generated through a reaction between LiOH and B₂O₃, and the other is a reaction between lithium borate (Li₂B₄O₇, Li₃BO₃, LiBO₂, or the like), and ammonia. Its essence is still using lithium borate as an active ingredient in the reaction, except that the chemical essence is hidden in the process of a single step operation. Embodiments 6 and 7 are in a similar way. It should be understood that, as long as any one of the foregoing borates is generated and is involved in a synthesis reaction of BNNS, it falls within the scope of the disclosure.

As be seen from the foregoing embodiments 1-7, the low-cost mass preparation method of the boron nitride nanosheet powder provided by some embodiments of the disclosure only needs to use a very inexpensive, and readily available solid metal borate as a starting material, can further complete a process of synthesizing a BNNS through borate nitrification in one step, and is characterized by simple process, and low cost. The reaction efficiency of starting materials can reach up to 85%, the purity of the purified product can reach up to 99%, the boron nitride nanosheet powder of more then a gram level can be prepared through a single batch reaction, and mass production can be achieved. Furthermore, an acid-washed product produced in the process can be further purified through crystallization to obtain a corresponding chloride byproduct, and can be further used for synthesizing a borate precursor as a starting material, thereby realizing recycling, which is environment friendly.

### Embodiment 8

An Al₁₈O₄O₃₃ (i.e., 9Al₂O₃.2B₂O₃) film having a thickness of about 100 nm was deposited on a silicon substrate using a magnetron sputtering approach, and then placed in a tube furnace. First, Ar was introduced at 1000 standard cc/min (sccm) to eliminate air within a furnace tube. Then the crucible was heated to 1300° C. in an atmosphere of Ar at 200 sccm and NH₃ at 200 sccm, and thermostatically controlled for 4 hours. Then NH₃ supply was switched off. Finally, Ar was introduced at 500 sccm, and the crucible was cooled to room temperature to prepare a continuous nitrogen nitride nanosheet film having a silicon wafer size. The continuous nitrogen nitride nanosheet film was proved to be boron nitride through analysis by IR, Raman, or the like. Then, as can be found through observing the continuous nitrogen nitride nanosheet film by TEM, SEM, or the like, the continuous nitrogen nitride nanosheet film was formed by aggregation of hexagonal boron nitride nanosheet monocrystals having a size of 1-50 μm, and a thickness between 1 and 100 atomic layers.

### Embodiment 9

A B-doped SiO₂ film having a thickness of about 500 nm (a doping amount of B therein was 5 at %) was deposited on a silicon substrate of 4 inches by electron beam evaporation, placed in a tube furnace, and vacuumized to 10⁻³ Pa. Then the crucible was heated to 1100° C. in an atmosphere of Ar at 200 sccm and NH₃ at 200 sccm, and thermostatically controlled for 2 hours. Then NH₃ supply was switched off. Finally, Ar was introduced at 500 sccm, and the crucible was cooled to room temperature to prepare a continuous nitrogen nitride nanosheet film having a length and a width of 4 inches.

### Embodiment 10

A Ca₃B₂O₆ (i.e., 3CaO.B₂O₃) film of 200 nm was deposited on a silicon substrate by electron beam evaporation, placed in a tube furnace, and vacuumized to 10⁻³ Pa. Then the crucible was heated to 1400° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

### Embodiment 11

A Mg₃B₂O₆ (i.e., 3MgO.B₂O₃) film of 200 nm was deposited on a silicon substrate by electron beam evaporation, placed in a tube furnace, and vacuumized to 10⁻³ Pa. Then the crucible was heated to 1300° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

### Embodiment 12

A ZnB₄O₇ film of 100 nm was deposited on a silicon substrate by electron beam evaporation, placed in a tube furnace, and vacuumized to 10⁻³ Pa. Then the crucible was heated to 1300° C. in an atmosphere of NH₃ at 300 sccm, and thermostatically controlled for 1 hour. Then NH₃ supply was switched off.

Finally, Ar was introduced at 200 sccm, and the crucible was cooled to room temperature to prepare a continuous nitrogen nitride nanosheet film having a silicon wafer size.

### Embodiment 13

A Li₂B₄O₇ film of 200 nm was deposited on a silicon substrate by electron beam evaporation, placed in a tube furnace, and vacuumized to 10⁻³ Pa. Then the crucible was heated to 1200° C. in an atmosphere of NH₃ at 300 sccm, and thermostatically controlled for 1 hour. Then NH₃ supply was switched off Finally, Ar was introduced at 200 sccm, and the crucible was cooled to room temperature to prepare a continuous nitrogen nitride nanosheet film having a silicon wafer size.

### Embodiment 14

A GaBO₃ (i.e., Ga₂O₃.B₂O₃) film of 200 nm was deposited on a silicon substrate by electron beam evaporation, placed in a tube furnace, and vacuumized to 10⁻³ Pa. Then the crucible was heated to 1250° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

### Embodiment 15

An InBO₃ (i.e., In₂O₃.B₂O₃) film of 300 nm was deposited on a silicon substrate by electron beam evaporation, placed in a tube furnace, and vacuumized to 10⁻³ Pa. Then the crucible was heated to 1200° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

### Embodiment 16

A H₂BeB₄O₇ film of 200 nm was deposited on a silicon substrate by electron beam evaporation, placed in a tube furnace, and vacuumized to 10⁻³ Pa. Then the crucible was heated to 1200° C. in an atmosphere of NH₃ at 300 sccm, and thermostatically controlled for 1 hour. Then NH₃ supply was switched off Finally, Ar was introduced at 200 sccm, and the crucible was cooled to room temperature to prepare a continuous nitrogen nitride nanosheet film having a silicon wafer size.

### Embodiment 17

A Ba₃B₂O₆ (i.e., 3BaO.B₂O₃) film of 100 nm was deposited on a silicon substrate by electron beam evaporation, placed in a tube furnace, and vacuumized to 10⁻³ Pa. Then the crucible was heated to 1250° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

### Embodiment 18

A Sr₃B₂O₆ (i.e., 3SrO.B₂O₃) film of 100 nm was deposited on a silicon substrate by electron beam evaporation, placed in a tube furnace, and vacuumized to 10⁻³ Pa. Then the crucible was heated to 1300° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

### Embodiment 19

A TiBO₃ (i.e., Ti₂O₃.B₂O₃) film of 200 nm was deposited on a silicon substrate by electron beam evaporation, placed in a tube furnace, and vacuumized to 10⁻³ Pa. Then the crucible was heated to 1400° C. in an atmosphere of NH₃ at 300 sccm, and thermostatically controlled for 1 hour. Then NH₃ supply was switched off. Finally, Ar was introduced at 200 sccm, and the crucible was cooled to room temperature to prepare a continuous nitrogen nitride nanosheet film having a silicon wafer size.

As can be seen from the foregoing embodiments 8-19, a preparation method of a continuous boron nitride nanosheet film provided by some embodiments of the disclosure can synthesize a continuous boron nitride nanosheet (i.e., the continuous boron nitride nanosheet film) directly on a substrate (such as the silicon substrate) without the need for a metal catalyst and any transfer process. The process is simple, controllable, and economical. The continuous boron nitride nanosheet film can be directly used as a growth substrate for two-dimensional nanomaterials, such as graphene, to facilitate forming a substrate and/or grid electrode of a graphene device. The continuous boron nitride nanosheet film has wide application prospects, and can achieve mass production.

### Embodiment 20

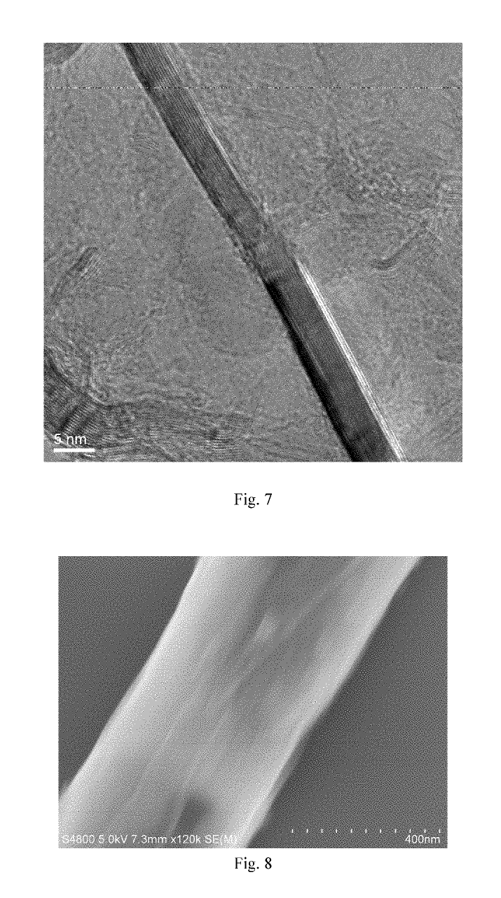

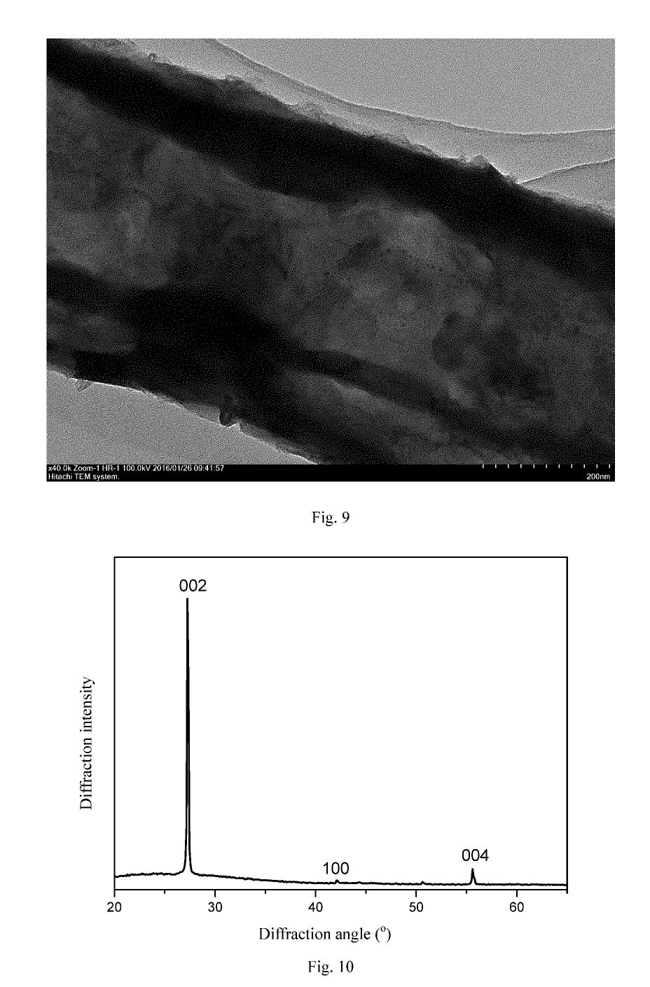

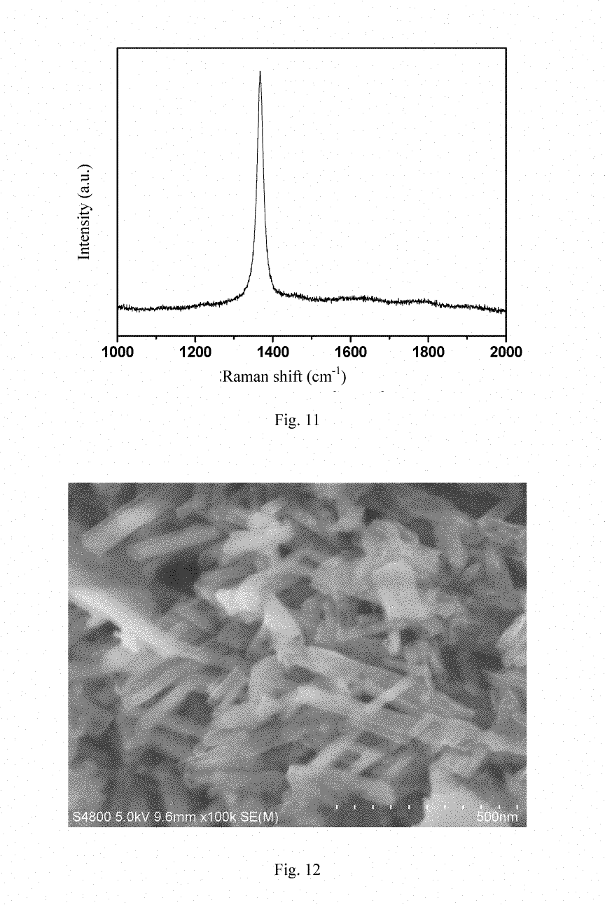

2 g of Mg₂B₂O₅ whisker having a diameter of about 50 nm and a length of about 10 μm was placed in an open alumina crucible, placed in a tube furnace, and vacuumized to 10⁻³ Pa. Then the crucible was heated to a temperature of 1300° C. after introducing NH₃ at 200 standard cc/min (sccm). After thermostatically controlling the crucible at 1300° C. for 180 min, NH₃ supply was switched off to introduce N₂ at 200 sccm. The crucible was cooled to room temperature in an atmosphere of N₂, and taken out to obtain a crude product. Then the obtained product was ultrasonically washed with water for 5 hours, filtered, and dried, to obtain a boron nitride nanotube having a purity of higher than 99%. The obtained nanotube has a diameter of about 500 nm, and a length of 10 μm. The target product can be obtained with 95% yield in the embodiment. FIG. 8 is a SEM image of a BNNT (nitrogen nitride nanotube) obtained in the embodiment. FIG. 9 is a TEM appearance image of the BNNT obtained in the embodiment. FIG. 10 and FIG. 11 are an XTD pattern and a Raman spectrum of the BNNT obtained in the embodiment respectively.

### Embodiment 21

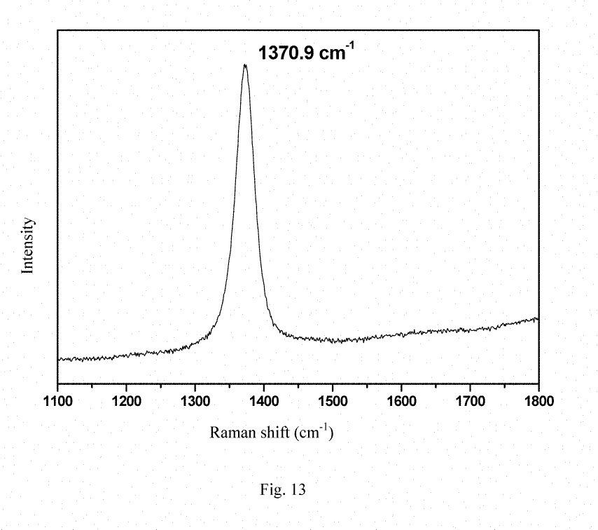

2 g of an Al₄B₂O₉ nanowhisker was placed in an open alumina crucible, and then placed in a tube furnace. Ar was introduced at 1000 standard cc/min (sccm) to eliminate air in a furnace tube. Then the crucible was heated to 1300° C. in an atmosphere of Ar at 200 sccm and NH₃ at 200 sccm. After thermostatically controlling the crucible at 1300° C. for 4 hours, NH₃ supply was switched off, and Ar was introduced at 500 sccm. The crucible was cooled to room temperature, and taken out to obtain a crude product. Then the obtained product was ultrasonically washed with 3 mol/L nitric acid for 1 hour, filtered, and dried, to obtain a boron nitride nanotube having a purity of higher than 99%. The target product can be obtained with 90% yield in the embodiment. FIG. 12 is a SEM image of a BNNT obtained in the embodiment, from which an average diameter of the BNNT nanotube being about 20 nm can be observed. FIG. 13 is a Raman spectrum of the BNNT obtained in the embodiment.

### Embodiment 23

A Mg₃B₂O₆ nanoribbon having a width of 100 nm and a length of 10 μm was placed in an open alumina crucible, placed in a tube furnace, and vacuumized to 10⁻³ Pa. Then the crucible was heated to 1400° C. in an atmosphere of NH₃ at 300 sccm. After thermostatically controlling the crucible at 1400° C. for 120 minutes, NH₃ supply was switched off, and Ar was introduced at 200 sccm. The crucible was cooled to room temperature, and taken out to obtain a crude product. Then the obtained product was ultrasonically washed with 3 mol/L nitric acid for 5 hours, filtered, and dried, to obtain a boron nitride nanoribbon having a width of 100 nm, a length of 10 μm, and a purity of higher than 99%. The target product can be obtained with 85% yield in the embodiment.

### Embodiment 24

A Ca₃B₂O₆ nanoribbon having a width of 200 nm and a length of 100 μm was placed in an open nitrogen nitride crucible, placed in a tube furnace, and vacuumized to 10⁻³ Pa. Then the crucible was heated to 1250° C. in an atmosphere of NH₃ at 300 sccm. After thermostatically controlling the crucible at 1250° C. for 2 hours, NH₃ supply was switched off, and Ar was introduced at 200 sccm. The crucible was cooled to room temperature, and taken out to obtain a crude product. Then the obtained product was ultrasonically washed with water for 2 hours, filtered, and dried, to obtain a boron nitride nanoribbon having a width of 200 nm, a length of 100 μm, and a purity of higher than 99%. The target product can be obtained with 80% yield in the embodiment.

Likewise, the foregoing embodiments 20-24 only illustrate the core contents of some embodiments in the disclosure by way of examples. The core of these embodiments is using a borate as a precursor. However, in practical production, the essence of the borate as a reactant may be hidden in some reaction processes, and is not easily recognized. For example, taking the preparation of a boron nitride nanotube with boric acid (H₃BO₃) and aluminum hydroxide (Al(OH)₃) as precursors as an example, two chemical reactions actually occur in the heating process: one is that an aluminum borate nanowhisker is generated through a reaction between H₃BO₃ and Al(OH)₃, and the other is that a boron nitride nanotube is generated through a reaction between the lithium borate nanowhisker and ammonia. Its essence is still using aluminium borate as an active ingredient in the reaction, except that the chemical essence is hidden in the process of a single step operation. It should be understood that, as long as a one-dimensional borate is generated and is involved in a synthesis reaction of BNNT or BNNS, it falls within the scope of the disclosure.

As can be proved through the foregoing embodiments 20-24, a process for preparing a one-dimensional boron nitride nanomaterial provided by the foregoing embodiments of the disclosure is simple and controllable with readily available and inexpensive starting materials. The conversion rates of the starting materials can reach up to 85%, and the purity of the purified target product can reach up to 99%, the one-dimensional boron nitride nanomaterial of more then a gram level can be prepared through a single batch reaction, and mass production can be achieved. Furthermore, the obtained one-dimensional boron nitride nanomaterial has advantages, such as excellent quality, and controllable appearance (e.g., a diameter and a number of walls of a boron nitride nanotube (BNNT) being controllable), and safe, environmentally friendly, and economical mass production (especially a boron nitride nanoribbon can be efficiently produced at low costs in an environmentally friendly way). The one-dimensional boron nitride nanomaterial can be widely used in many fields, such as deep ultraviolet light emitting, composite materials, heat dissipating materials, friction materials, drug loading, and catalyst carriers.

It should be understood that the above embodiments only illustrate the technical concepts and features of the disclosure, and are intended to enable those skilled in the art to understand the contents of the disclosure and implement the disclosure accordingly, but are not intended to limit the scope of protection of the disclosure. All equivalent alterations or modifications made according to the spiritual essence of the disclosure shall fall within the scope of protection of the disclosure.

1. A preparation method of a boron nitride nanomaterial, comprising: heating a precursor in a nitrogen atmosphere to 1000-1500° C., and thermostatically controlling the precursor to prepare the boron nitride nanomaterial; the precursor comprising boron, and at least one metal element, and/or at least one non-metallic element rather than boron, the metal element being at least one selected from the group consisting of lithium, beryllium, magnesium, calcium, strontium, barium, aluminum, gallium, indium, zinc, and titanium, the non-metallic element comprising silicon, and the nitrogen atmosphere is selected from the group consisting of an ammonia atmosphere, a nitrogen atmosphere, and a mixed atmosphere formed by at least one of ammonia or nitrogen, and argon.

2. The preparation method according to claim 1, comprising: using a solid boron source as the precursor, heating the solid boron source in the nitrogen atmosphere to 1000-1500° C., thermostatically controlling the solid boron source, then cooling to room temperature in a protective atmosphere to obtain a crude product, and then post-processing the crude product to obtain a boron nitride nanosheet powder; the solid boron source selected from borates, the borates selected from borates containing at least one element of lithium, beryllium, magnesium, calcium, strontium, barium, aluminum, gallium, indium, zinc, or titanium.

3. The preparation method according to claim 2, wherein the solid boron source is any one selected from the group consisting of calcium borate, magnesium borate, lithium borate, aluminum borate, and zinc borate, and a combination of two or more thereof.

4. The preparation method according to claim 2, comprising: heating the solid boron source in a nitrogen atmosphere to a temperature of higher than 1250° C., and lower than or equal to 1500° C., and thermostatically controlling the solid boron source.

5-6. (canceled)

7. The preparation method according to claim 2, wherein the protective atmosphere comprises a nitrogen atmosphere, an argon atmosphere, or a mixed atmosphere of nitrogen and argon.

8. The preparation method according to claim 2, wherein the post-processing comprises: washing the crude product with an acid solution, filtering, and then drying the crude product at 60-80° C. for 1-12 hours to obtain the boron nitride nanosheet; and the acid solution is at a concentration of 0.1-6 mol/L, wherein the acid contained therein can react with a byproduct in the crude product to form a soluble substance.

9-10. (canceled)

11. The preparation method according to claim 1, comprising: using a precursor film coated on a substrate as the precursor, heating the precursor film in a nitrogen atmosphere to 1000-1400° C., and thermostatically controlling the precursor film, to prepare a continuous boron nitride nanosheet film; the precursor film comprising at least three elements, wherein two elements thereof are boron, and oxygen respectively, while the other element is any one selected from the group consisting of lithium, beryllium, magnesium, calcium, strontium, barium, aluminum, gallium, indium, zinc, titanium, and silicon, and a combination of two or more thereof.

12. The preparation method according to claim 11, wherein the precursor film is directly formed on surface of the substrate; and/or, a thickness of the precursor film is 1-500 nm; and/or, there is no metal catalyst layer between the continuous boron nitride nanosheet film and the substrate; and/or, a precursor contained in the precursor film comprises a component of (MₓO_{y})ₘ.(B₂O₃)ₙ, wherein M is any one selected from the group consisting of lithium, beryllium, magnesium, calcium, strontium, barium, aluminum, gallium, indium, zinc, titanium, and silicon, and a combination of two or more thereof, m/n=1:10-1000:1, if M is a monovalent metal ion, then x=2y, if M is a divalent metal ion, then x=y, if M is a trivalent metal ion, then 2y=3x, and if M is a tetravalent Si ion, then y=2x.

13. (canceled)

14. The preparation method according to claim 11, comprising: coating the precursor film on the substrate, then heating the precursor film in the nitrogen atmosphere to 1000-1400° C., and thermostatically controlling the precursor film, thereby forming the continuous boron nitride nanosheet film on the surface of the substrate, and forming a metal oxide layer or a silicon oxide layer on the substrate and the continuous boron nitride nanosheet film.

15-16. (canceled)

17. The preparation method according to claim 11, wherein the nitrogen atmosphere is selected from ammonia, and/or nitrogen, and/or a mixed atmosphere formed by ammonia, and/or nitrogen, and an inert gas; and/or the substrate comprises a silicon substrate, or a silicon oxide substrate.

18. (canceled)

19. The preparation method according to claim 1, comprising: using a one-dimensional borate precursor as the precursor, heating the one-dimensional borate precursor in the nitrogen atmosphere to 1000-1500° C., thermostatically controlling the one-dimensional borate precursor, then cooling to room temperature in a protective atmosphere to obtain a crude product, and then post-processing the crude product to obtain a one-dimensional boron nitride nanomaterial; the one-dimensional borate precursor selected from one-dimensional borate materials containing at least one element of lithium, beryllium, magnesium, calcium, strontium, barium, aluminum, gallium, indium, zinc, or titanium, and the one-dimensional borate material comprises any one of a borate whisker, a borate nanorod, a borate nanowire, or a borate nanoribbon.

20. (canceled)

21. The preparation method according to claim 19, comprising: heating the one-dimensional borate precursor in a nitrogen atmosphere to a temperature of higher than 1200° C., and lower than or equal to 1500° C., and thermostatically controlling the one-dimensional borate precursor.

22-23. (canceled)

24. The preparation method according to claim 19, wherein the protective atmosphere comprises a nitrogen atmosphere, an argon atmosphere, or a mixed atmosphere of nitrogen and argon.

25. The preparation method according to claim 19, wherein the post-processing comprises: washing the crude product with an acid solution, filtering, and then drying the crude product at 60-80° C. for 1-12 hours, to obtain the one-dimensional boron nitride nanomaterial; and the acid solution is at a concentration of 0.1-6 mol/L, wherein the acid contained therein can react with a byproduct in the crude product to form a soluble substance.

26. (canceled)

27. A boron nitride nanosheet powder prepared by the method according to claim 2, the boron nitride nanosheet powder being a hexagonal boron nitride nanosheet having a purity of higher than 99%, the hexagonal boron nitride nanosheet having a thickness of 1-20 atomic layers, and a radial dimension of 1-20 μm.

28. A continuous boron nitride nanosheet film prepared by the method according to claim 11, the continuous boron nitride nanosheet film formed by aggregation of hexagonal boron nitride nanosheet monocrystals having a size of 1-50 μm, a thickness of the continuous boron nitride nanosheet film being between 1 and 100 atomic layers.

29. (canceled)

30. A one-dimensional boron nitride nanomaterial prepared by the method according to claim 19, the one-dimensional boron nitride nanomaterial comprising a boron nitride nanotube or a boron nitride nanoribbon, and a wall thickness of the boron nitride nanotube is between monoatomic layer and polyatomic layers, and a length and a diameter of the boron nitride nanotube depend on the employed precursor; or a thickness of the boron nitride nanoribbon is between monoatomic layer and polyatomic layers, and a width and the length of the boron nitride nanotube depend on a width and a length of the employed precursor.

31. (canceled)
